(19) United States
(12) Patent Application Publication
(10) Pub. No.: US 2002/0010652 A1
(43) Pub. Date: Jan. 24, 2002

(54) Vendor ID tracking for e-marker

(75) Inventor: Yuichiro Deguchi, San Mateo, CA (US)

Correspondence Address: Seong-Kun Oh, Sierra Patent Group, P.O. Box 6149, Stateline, NV, 89449, US

(73) Assignee: Sony Corporation

(21) Appl. No.: 09/905,356

(22) Filed: Jul. 13, 2001

Related U.S. Application Data
(60) Provisional application No. 60/218,453, filed on Jul. 14, 2000.

(51) Int. Cl. G06F 17/60; G06F 15/16; H04B 3/00

(52) U.S. Cl. 705/26; 709/229; 381/77

(57) ABSTRACT

Method and system for tracking music marker device vendor and music marker devices sold by the device vendor such that when the user of the music marker device decides to purchase a CD or an audio cassette of the bookmarked music clip, the user is directed to the web site of the user's device vendor or provided with purchase information for the purchase of the CD or the audio cassette from the user's device vendor.

### RELATED APPLICATION

This application claims priority under 35 USC §119 to provisional application No. 60/218,453 titled “Vendor ID Tracking For E-marker” filed on Jul. 14, 2000 which is herein incorporated by reference.

### FIELD OF THE INVENTION

The present invention relates to electronic music markers. More particularly, the present relates to electronic markers which are capable of interfacing with other electronic markers to exchange information related to marked information and access data such as password for web access.

### BACKGROUND OF THE INVENTION

With increase in portable electronic devices such as personal digital assistants (PDAs) and WAP (Wireless Application Protocol) enabled mobile telephone and so on, there has been a steady increase in these devices capable of performing more operations.

Sony Corporation and its U.S. subsidiary, Sony Electronics, Inc., introduced an electronic music marker device which is capable of “bookmarking” a music clip while being played on a radio and is capable of recalling the information related to the bookmarked music clip such as the name of the song, the artist, the album containing the song and so on. Using the electronic music marker device, a user can conveniently access the music clip information that the user listened to on the radio at a later time without the need to memorize the information or wait hopefully for the disc jockey on the radio to provide that information. In this manner, if the user wants to, for example, purchase the music album which the user has marked using the electronic music marker device, the user can easily identify the necessary information related to the marked music clip from the e-marks provided by the electronic music marker device.

Many retail stores that carry electronics goods also carry music CDs and audio cassettes. Indeed, one can even find supermarkets and grocery stores that also carry some types of electronics goods as well as music CDs and audio cassettes. Moreover, many brick-and-mortar type retail stores also concurrently operate the sale and promotion of their goods through an on-line store where customers may purchase goods offered over an internet connection to the retailer's on-line store.

For retail stores that carry the electronic music marker device for sale to the consumers, it would be advantageous if the consumers who have purchased the electronic music marker device to return to the retail store to subsequently purchase the bookmarked music CDs and/or cassettes. Indeed, for on-line electronics retail stores that offer both the electronic music marker devices and music CDs or audio cassettes, it would be desirable for those consumers who have purchased the electronic music marker devices to be directed to the on-line store from which the consumers has purchased their respective electronic music marker devices.

### SUMMARY OF THE INVENTION

In view of the foregoing, a vendor tracking system for data marking device of one embodiment includes a data network, a user terminal coupled to the data network configured to transmit a signal including information corresponding to a marked data, a vendor terminal configured to transmit a vendor identification code, and a server terminal coupled to the data network configured to receive the signal from the user terminal and the vendor identification code, the server terminal further configured to transmit information corresponding to the vendor identification code and the received signal to the user terminal.

A vendor tracking system for a music marker device of another embodiment includes a data network, a music marker device configured to store information corresponding to one or more of a music broadcast, a user terminal coupled to the marker device, the user terminal configured to receive the stored information corresponding to the one or more of a music broadcast from the marker device and an identification code corresponding to the marker device for transmission over the data network, a vendor terminal configured to transmit a vendor identification code and one or more of purchased marker device identification codes corresponding to the vendor identification code; and a server terminal coupled to the data network configured to receive the information corresponding to the one or more of the music broadcast and the marker device identification code from the user terminal, and the vendor identification code and the one or more the purchased marker device identification codes corresponding to the vendor identification code, the server terminal further configured to compare the identification code received from the user terminal with the one or more of the identification codes received from the vendor terminal, and accordingly, to transmit information to the user terminal based on the comparison.

A method of a further embodiment includes receiving a vendor identification code and one or more data marking device identification code corresponding to the vendor identification code, receiving one or more marked data and a corresponding data marking device identification code, comparing the data marking device identification code corresponding to the vendor identification code with the data marking device identification code corresponding to the one or more marked data, and transmitting purchase information related to the marked data from a vendor corresponding to the received vendor identification code based on the comparing step.

A method of still another embodiment includes purchasing a data marking device from a vendor, marking one or more broadcast data, communicating with a data marking device service provider, and receiving purchase information corresponding to the marked one or more broadcast data for purchase from the vendor.

A vendor tracking system for data marking device of still yet another embodiment includes means for receiving a vendor identification code and one or more data marking device identification code corresponding to the vendor identification code, means for receiving one or more marked data and a corresponding data marking device identification code, means for comparing the data marking device identification code corresponding to the vendor identification code with the data marking device identification code corresponding to the one or more marked data, and means for transmitting purchase information related to the marked data from a vendor corresponding to the received vendor identification code based on the comparing means.

These and other features and advantages of the present invention will be understood upon consideration of the following detailed description of the invention and the accompanying drawings.

### BRIEF DESCRIPTION OF THE DRAWINGS

FIG. 1 illustrates an overall vendor ID tracking system for an electronic music marker device in accordance with one embodiment;

FIG. 2 illustrates a block diagram of the electronic bookmarking device shown in FIG. 1;

FIG. 3 illustrates an electronic music marker device and cradle-type docking connection;

FIG. 4 is one embodiment of a database illustration of the bookmarks in a storage unit of the electronic music marker device;

FIG. 5 is a flowchart for illustrating one embodiment of the electronic music marker device operation; FIG. 6 is a flowchart for illustrating one embodiment of downloading data from the user's electronic music marker device account to the music marker device;

FIG. 7 illustrates one embodiment of a user terminal of the electronic music marker device vendor ID tracking system shown in FIG. 1;

FIG. 8 illustrates one embodiment of the server terminal of the electronic music marker device vendor ID tracking system shown in FIG. 1;

FIG. 9 illustrates one embodiment of a user account database of the server terminal database storage unit shown in FIG. 8;

FIG. 10 illustrates one embodiment of a playlist database of the server terminal data storage unit shown in FIG. 8;

FIG. 11 illustrates one embodiment of a user playlist database of the server terminal data storage unit shown in FIG. 8;

FIG. 12 illustrates one embodiment of a vendor ID database of the server terminal data storage unit shown in FIG. 8;

FIG. 13 is a graphical illustration of a user terminal display unit for displaying user electronic music marker device account in the vendor ID tracking system of one embodiment;

FIG. 14 illustrates a flowchart for illustrating vendor ID tracking system for device vendor of one embodiment; and

FIG. 15 illustrates a flowchart for illustrating vendor ID tracking system at server terminal of one embodiment.

### DETAILED DESCRIPTION

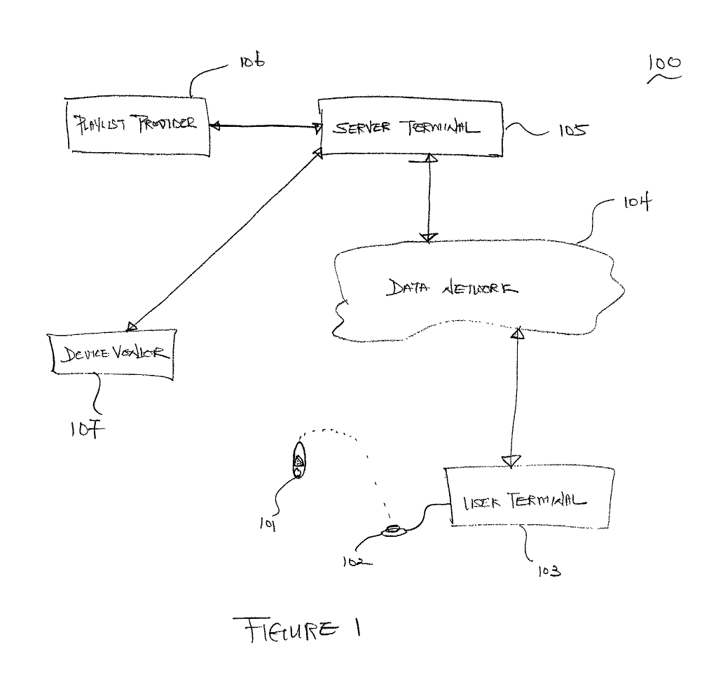

FIG. 1 illustrates an overall vendor ID tracking system for an electronic music marker device in accordance with one embodiment. Referring to FIG. 1, vendor ID tracking system for an electronic music marker device 100 includes user terminal 103 connected to data network 104 such as the internet via connection protocols such as TCP/IP, Appletalk, using connection interface unit (not shown) such as a dial-up modem through an internet service provider (ISP), a broadband network such as a DSL or cable modem, a T1 or LAN connection, or any other means for connecting to the internet. User terminal 103 is configured to connect to electronic music marker device 101 via cradle type connection unit 102, and configured to receive, upon synchronization operation with music marker device 101, bookmark information stored in music marker device 101. In one embodiment, the bookmark information transmitted from music marker device 101 to user terminal 103 may include music marker device 101 unique device identification code, the number of stored bookmarks, and corresponding date and time stamp for each stored bookmarks.

Also shown in FIG. 1 is server terminal 105 connected to data network 104 for communicating with user terminals 103 for data transfer. Moreover, as further shown in FIG. 1, server terminal 105 is coupled to playlist provider 106. Playlist provider 106 is configured to transmit playlist information corresponding to registered radio station broadcasts such as the title, artist and album information for the music broadcast from the registered radio station.

In one aspect, playlist provider 106 may be configured to periodically transmit information related to the music broadcast from the registered radio stations over a predetermined period of time. For example, depending upon factors such as the target market for the registered radio station or the geographic location of the registered radio station, playlist provider 106 may be configured to transmit broadcast music clip information to server terminal 105 within ten minutes from the termination of the respective music broadcast, or alternatively, within 12 or 24 hours from a predetermined broadcast cutoff time such as 10 PM or midnight. Moreover, while playlist provider 106 is shown as communicating with server terminal 105 via a dedicated connection, within the scope of the present invention, server terminal 105 and playlist provider 106 may communicate via a connection through data network 104 for data transfer.

Referring again to FIG. 1, vendor ID tracking system for an electronic music marker 100 also includes device vendor 107. In one embodiment, device vendor 107 may be configured to transmit vendor ID information to server terminal 105 as well as music marker device ID information which has been sold by device vendor 107. Device vendor ID information may be a uniquely assigned alphanumeric combination or any type of identification coding which can uniquely identify each particular device vendor 107. Indeed, while vendor ID tracking system for an electronic music marker 100 of FIG. 1 is shown with only one device vendor 107 and one electronic music marker device 101, within the scope of the present invention, multiple device vendors and music marker devices may be supported in the vendor ID tracking system. As will be discussed in further detail below, the device vendor 107 may transmit its unique device vendor ID to server terminal 105 for storage therein.

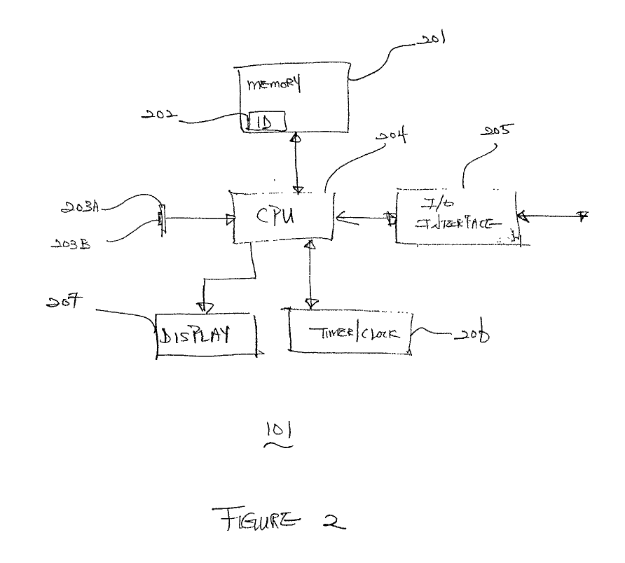

FIG. 2 illustrates a block diagram of the electronic music marker device shown in FIG. 1. Referring to FIG. 2, music marker device 101 includes memory 201 such as a Random Access Memory (RAM) and a Read-Only Memory (ROM), and stored thereon is a unique bookmarking device identification code 202 which can include a predetermined combination of letters or numbers, or a combination of both. In one embodiment, identification code 202 can include a thirteen-digit number which is unique to each bookmarking device and is pre-stored in the ROM portion of memory 201.

Further shown in FIG. 2 is controller (CPU) 204 which is configured to control the various components of bookmarking device 101 as shown such as display unit 207, input units 203A, 203B such as bookmarking buttons for bookmarking broadcast music clips over a registered radio or television station, or for bookmarking locations, input/output (I/O) interface 205, clock/timer 206, and memory 201. As can be seen from FIG. 2, upon receiving an input signal from a user of music marker device 101 via input units 203A, 203B, controller 204 may be configured to access the various components of device 101 depending upon the input command received from the user, to perform one or a plurality of processings, executing the input command of the user.

Moreover, I/O interface 205 of music marker device 101 shown in FIG. 2 may be configured to, under the control of controller 204, interface with server terminal 105. Display unit 207 in accordance with one embodiment of the present invention may include a liquid crystal display (LCD), a plasma-type display, and the like, configured to display text or image data, or a combined text and image data. Furthermore, as discussed above, the input unit 203A, 203B may include spring-loaded type input buttons for operation by the user's finger. Alternatively, input unit 203A, 203B may include a touchpad-type screen integrated with display unit 207 for simultaneously inputting and displaying information, where the user can tap the pressure-sensitive screen using a stylus or the like to enter input commands. Timer/clock 206 of music marker device 101 in accordance with one aspect of the present invention may be configured to provide actual time information as well as generate an elapsed time information depending upon the input command from the user under the control of controller 204.

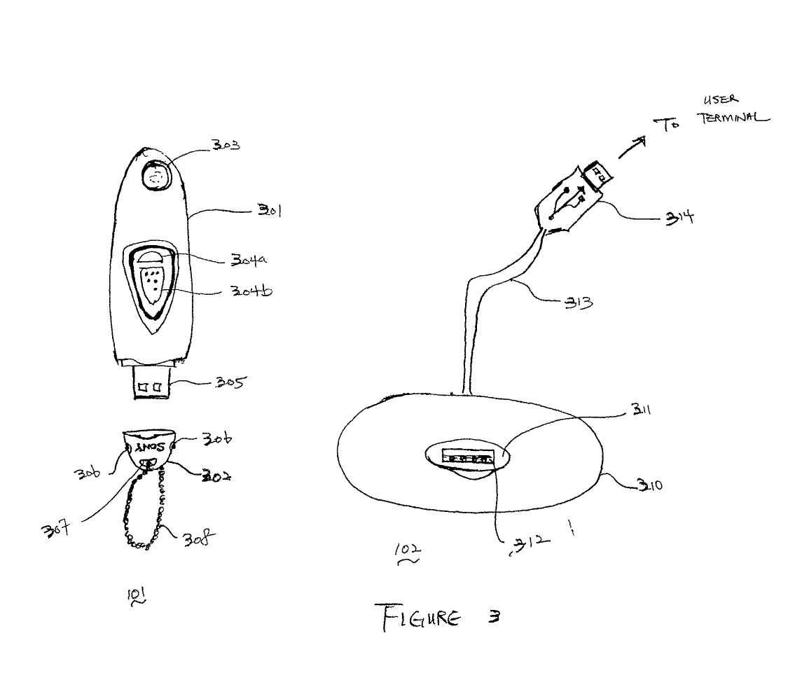

FIG. 3 illustrates an electronic music marker device and cradle-type docking connection of one embodiment. Referring to FIG. 3, music marker device 101 includes a housing comprising body 301 and cap 302. Body 301 is provided with e-mark button 303 which is configured for user input commands.

Also provided on body 301 are display panels 304a and 304b which are configured to display the number of user inputted e-marks and the type of registered broadcast station for the corresponding e-marks, respectively.

Finally, body 301 includes communication port 305 such as a USB port which is integrated onto body 301 such that, as will be discussed in further detail below, body 301 may be placed on top of cradle type connection 102 with communication port 305 capable of being plugged into the corresponding port on cradle 102.

Cap 302 can be attached to body 301 when access to communication port 305 is unnecessary. As shown, cap 302 is provided with a pair of release/lock buttons 306 on either side of cap 302 such that by depressing release/lock buttons 306 when cap 302 is locked with body 301, cap 302 can be released from a locked position and communication port 305 may be accessed. Furthermore, cap 302 is provided with hole 307 substantially at its edge position such that link chain 308 can be looped through hole 307 to allow the user to attach the music marker device 101 to a key chain or the like.

Referring back to FIG. 3, cradle-type connection 102 is provided with cradle base 310 substantially flat on its bottom surface (not shown) to rest cradle 102 on a flat surface such as a desktop and a book shelf. On the other side of the bottom surface of cradle 102 is receiving section 311 substantially positioned on the middle of cradle 102, where communication port 312 such as a USB port is provided for connection to communication port 305 of the music marker device 101. Also shown in FIG. 3 is cable 313 attached to cradle connection 102 with a communication port 314 at its other end. In this manner, cradle 102 may be connected to user terminal 103 accessing the user's electronic music marker device account over an internet connection.

Additional detailed information relating to the operation of the electronic music marker device 101 may be found in pending application Ser. No. 09/126,007 filed on Jul. 29, 1998 and application Ser. No. 09/401,105 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

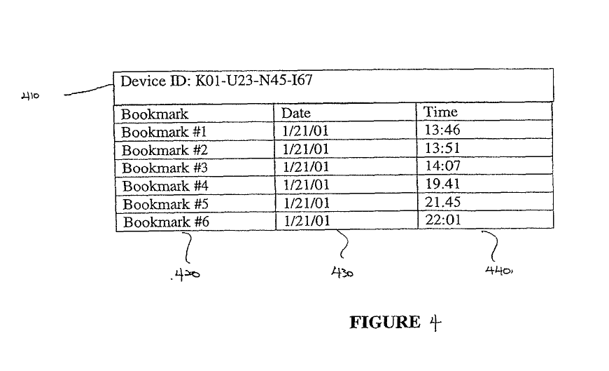

FIG. 4 is one embodiment of a database illustration of the bookmarks in a storage unit of the electronic music marker device. Referring to FIG. 4, storage unit such as a random access memory (RAM) and/or a read-only memory (ROM) may be configured to store device ID unique for each marker device 101 in device ID field 410. Additionally, storage unit of marker device 101 may also be configured to store bookmarks input by the user in bookmark field 420, with a corresponding date and time information (for example, a time stamp) for the respective bookmarks in date field 430 and time field 440, respectively. In this manner, when music marker device 101 is connected to server terminal 105 via user terminal 103, information stored in marker device storage unit such as the bookmarks and the corresponding date and time stamp information may be transmitted to server terminal 105.

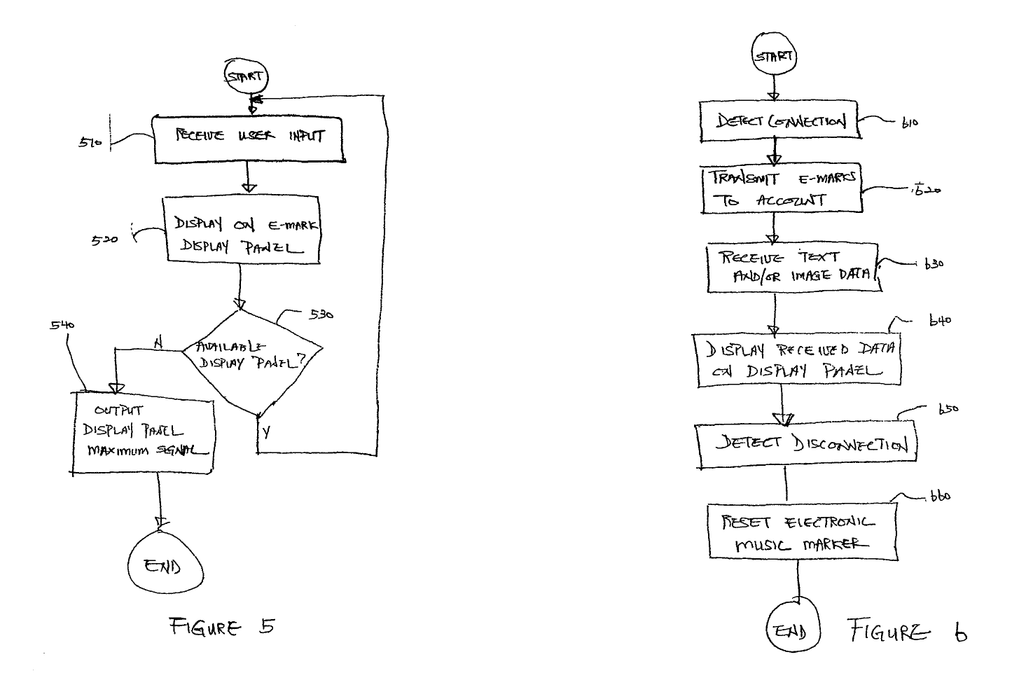

FIG. 5 is a flowchart for illustrating one embodiment of the electronic music marker device operation. Referring to FIG. 5, at step 510, electronic music marker device 101 detects user's input operation of e-mark buttons 203A, 203B. Then, at step 520, music marker device 101 illuminates or flashes a corresponding e-mark display panel 304a, 304b. As discussed above, in one embodiment, the corresponding e-mark display panel 304a, 304b may be configured to display time and/or date information of the user's input operation of e-mark buttons 203A, 203B.

At step 530, music marker 101 determines whether all available e-mark display panels 304a, 304b are being used (for example, illuminated or flashing in response to user's input operation of e-mark button 203A, 203B). If it is determined that there are e-mark display panels 304a, 304b available, music marker device 101 waits for further input operation by the user at step 510. On the other hand, if it is determined at step 530 that all available e-mark display panels 304a, 304b are in use, then at step 540, electronic music marker device 101 generates an output signal to inform the user that music marker device 101 has reached its maximum number of e-marks that it can handle, and the procedure ends. In one embodiment, the output signal from music marker device 101 to inform the user that it has reached its maximum number of e-marks it can handle may be an audible output signal such as an audible tone via an audio output terminal (not shown). Alternatively, music marker device 101 may be configured to flash all e-mark display panels 203A. 203B simultaneously for a predetermined period of time to visually indicate to the user that it has reached its maximum number of e-marks that it can handle.

FIG. 6 is a flowchart for illustrating one embodiment of downloading data from the user's electronic music marker device account to the music marker device. Referring to FIG. 6, at step 610, music marker device 101 detects a connection to user terminal 103 connected to the internet. After the user enters the user's account information and performing necessary electronic music marker device account access steps at user terminal 103, at step 620, data corresponding to the e-marks (bookmarks) stored in music marker device 101 is transmitted to the user's electronic music marker device account via gateway (user) terminal 103, and in response, the corresponding text and/or image (including video) data are retrieved from server terminal 105 of, for example, emarker.com web site and transmitted to the user's electronic music marker device account. Then, at step 630, the text and/or image data corresponding to each e-marks are downloaded onto music marker device 101. At step 640, the downloaded text and/or image data are displayed on each corresponding e-mark display panel 304a, 304b on music marker device 101.

When the user disconnects music marker device 101 from user terminal 103, the termination of the is detected at step 650, and at step 660, music marker device 101 is reset such that previously stored e-marks inputted by the user may be erased from the storage unit of music marker device 101, and correspondingly, the illuminated e-mark display panels 304a, 304b are turned off. The user may then operate e-mark button 203A, 203B again to input additional bookmarks of music clip broadcasts from registered radio and television broadcast stations.

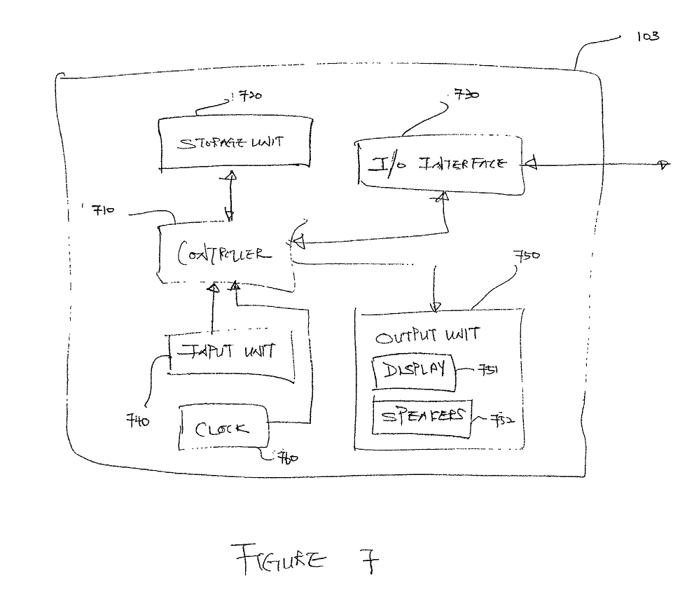

FIG. 7 illustrates one embodiment of a user terminal of the electronic music marker device in the vendor ID tracking system. Referring to FIG. 7, user terminal 103 (FIG. 1) in one embodiment may include controller 710, storage unit 720, I/O interface unit 730, input unit 740, output unit 750 and clock 760. Storage unit 720 of user terminal 103 may include one or more of an internal or an external storage device such as a hard disc drive (HDD), a CDRW drive, or a zip drive. Input unit 740 of user terminal 103 may include one of or a combination of a keyboard, a mouse, a touchpad input device and a voice-recognition type input terminal including a microphone with corresponding software installed in user terminal 103 for performing input operations by voice commands. Controller 710 is coupled to input unit 740 and accordingly, may be configured to process the input data received from input unit 740. Storage unit 720 is similarly coupled to controller 720, and may be configured to store inputted data received from input unit 740 or other data received by user terminal 103. Clock 760 also coupled to controller 710 may be configured to provide time information to controller 710 which, in turn, may be stored in storage unit 720 as discussed in further detail below.

Referring back to FIG. 7, I/O interface unit 730 in one embodiment may be coupled to controller 710, and may be configured to interface with other user terminals 103 in the network or to communicate with server terminal 105. In one embodiment, I/O interface circuit 730 of user terminal 103 may include a communication port configured to connect to the date network 104 such as the internet via connections such as, but not limited to, a modem dial-up through an internet service provider (ISP), a DSL or cable modem-type connection, and a T1, IDSN or LAN type connection. Communication port integrated in I/O interface circuit 230 may include, among others, one of a USB port, a serial port, a parallel port, an IEEE 1394 communication port, a IrDA communication port, and a Bluetooth enabled communication port.

Referring again to FIG. 7, output unit 750 of user terminal 103 may include display unit 751 and speakers 752. Display unit 751 may be configured to output text, image (for example, in jpg or gif formats) or video data (for example, in .avi or .mpeg formats) while speakers may be configured to output sound data in the form of, for example, .wav file format. In this manner, user terminal 103 in one embodiment may be configured to communicate with server terminal 105 over the internet connection 104.

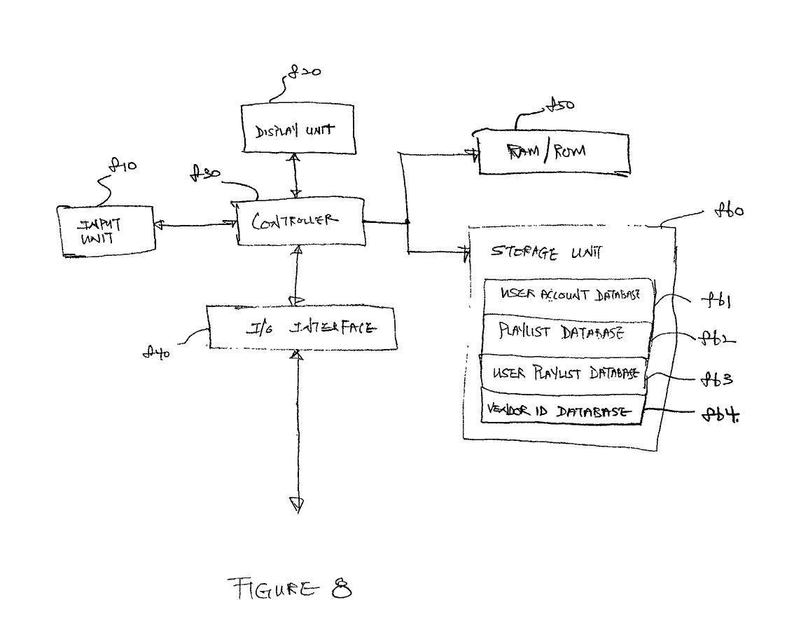

FIG. 8 illustrates one embodiment of a server terminal in the electronic music marker device vendor ID tracking system. Referring to FIG. 8, server terminal 105 includes display unit 820, input unit 810, controller 830, input/output (I/O) interface unit 840, memory (RAM/ROM) 850, and storage unit 860. Display unit 820 may be configured to display various information including the status of server terminal 105 connection, data transfer processing status, data upload information, and any other information related to the operation of server terminal 105 (FIG. 1).

Input unit 810 of server terminal 105 may be configured to provide input means for operations such as server terminal maintenance, data backup, data query and so on. As can be seen, both display unit 111 and input unit 810 are coupled to controller 830. In one embodiment, controller 830 may be configured to control the display of information on display unit 820 in accordance with input operations received from input unit 810. Alternatively, server terminal 105 may exclude display unit 820. Referring back to FIG. 8, controller 830 of server terminal 105 is further coupled to memory 850, storage unit 860 and I/O interface unit 840. In one embodiment, controller 830 may be configured to control data access, retrieval and updating of the stored data in storage unit 860. Moreover, controller 830 may further be configured to control the operation of I/O interface unit 840 which communicates with other terminals connected in the network over the internet connection 104. In one embodiment, I/O interface circuit 840 may include a communication port configured to connect to other terminals in the network via connections such as, but not limited to, a modem dial-up through an internet service provider (ISP), a DSL or cable modem-type connection, and a T1, ISDN or LAN type connection. Communication port integrated in I/O interface circuit 840 may include, among others, one of a USB port, a serial port, a parallel port, an IEEE 1394 communication port, a IrDA communication port, and a Bluetooth enabled communication port.

Referring again to FIG. 8, storage unit 860 of server terminal 105 may include internal or external storage devices such as a hard disc drive (HDD), a CD-RW drive, or a zip drive. In one embodiment, storage unit 860 may be configured to storage a variety of data received by server terminal 105 and processed by server terminal 105. In particular, storage unit 860 may include user account database 861, playlist database 862, user playlist database 863, and vendor ID database 864.

User account database 860 as discussed in further detail below may be configured to store information related to the registered users of the emarker system such as, for example, user name, address, account name, account password, and account status. Playlist database 862 may be configured to store playlists for each registered radio station broadcasts periodically received from playlist provider 106. Additionally, user playlist database 863 may be configured to store music clip broadcast playlists corresponding to the user's bookmarks. Lastly, vendor ID database 864 may be configured to store vendor ID data received from device vendor 107 (FIG. 1) and the device unique IDs of the electronic music marker devices sold by the particular device vendor 107.

As further shown in FIG. 8, controller is coupled to memory 850 for accessing software and drivers for performing the various functions and processes of server terminal 105 for the electronic music marker device vendor ID tracking system. Indeed, in one embodiment, the electronic music marker device vendor ID tracking system may be embodied as a computer program developed using an object oriented language that allows the modeling of complex systems with modular objects to create abstractions that are representative of real world, physical objects and their interrelationships. However, it would be understood by one of ordinary skill in the art that the various embodiments as described herein may be implemented in many different ways using a wide range of programming techniques as well as general purpose hardware systems or dedicated controllers.

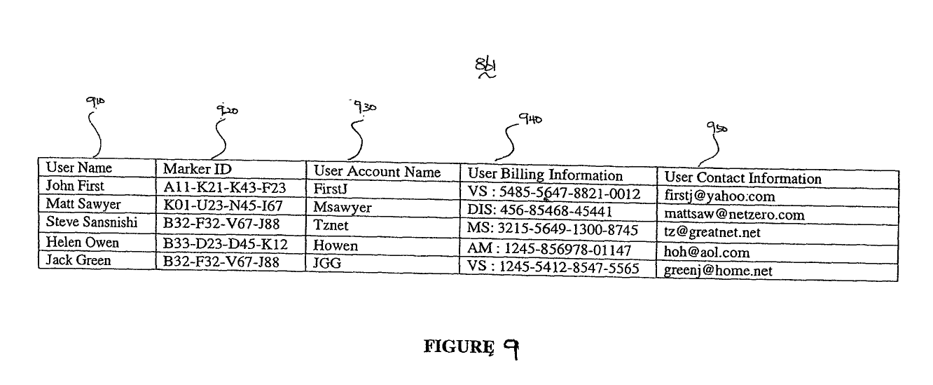

FIG. 9 illustrates a user account database of server terminal 105 storage unit 860 shown in FIG. 8. Referring to FIG. 9, user account database 861 may include a user name field 910, a marker identification (ID) field 920, a user account name field 930, a user billing information field 940, and a user contact information field 950. As can be seen from the figure, user name field 910 may be configured to store the name of the user of music marker device 101, while marker ID field 920 may be configured to store the music marker device ID corresponding to the respective device user name. For example, marker ID field 920 corresponding to the user John First may be configured to store the value “A11-K21-K43-F23” which corresponds to the marker device ID of John First. Moreover, marker ID field 920 corresponding to the user Matt Sawyer may be configured to store the value “K01-U23-N45-167” as the marker ID for Matt Sawyer. In this manner, for each user and their respective electronic music marker devices, a unique marker ID may be stored in user account database 861.

Referring back to FIG. 9, user account name field 930 may be configured to store each user's account name, typically provided by the user, or alternatively, automatically assigned by the server terminal 105 (FIG. 1) upon user registration at the electronic music marker device web site. For example, user account name field 930 corresponding to the user John First may include “FirstJ” indicating John First's account name. While the user account names stored in the user account name field 930 are shown as a combination of each user's initials and/or names, in one aspect, the user account name may be a combination of letters and number, a unique series of number, or any other data string which may uniquely identify the respective user.

As can be further seen from FIG. 9, user billing information field 940 may be configured to store billing information such as credit card number, expiration date, and the type of credit card for each user. For example, user billing information field 940 corresponding to the user Helen Owen may be configured to store the value “AM” indicating her American Express card, having a card number “1245-856978-01147”. In another aspect, user billing information field 940 may include the user's bank account information such as the user's bank account name, account number, and so on. Moreover, in other embodiments, the user billing information field 940 may include information corresponding to the user's transferable assets that the user wishes use as the preferred payment method for charges incurred, such as, for example, the user's frequent flier miles, the user's bank debit card, and so on. Referring again to FIG. 9, user contact information field 750 may be configured to store contact information corresponding to each user. For example, in one aspect, user contact information field 950 may be configured to store email addresses of each respective user. Alternatively, user contact information field 950 may be configured to store a telephone number, a facsimile number, a pager number or any other type of contact information for the respective users. Moreover, user account database 861 may be further configured to store other relevant information corresponding to the users. In this manner, from the information stored in user account database 861, server terminal 105 may retrieve information related to the respective user's account as well as to update the information stored in user account database 861 based on received playlists from playlist provider 106 and/or the users themselves who are updating their corresponding account.

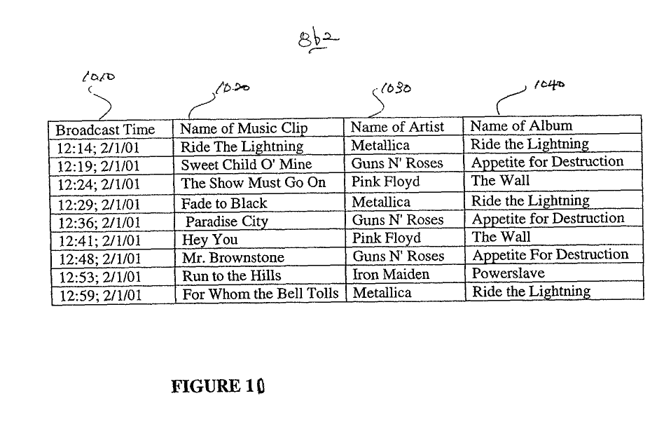

FIG. 10 illustrates one embodiment of a playlist database of the server terminal data storage unit shown in FIG. 8. Referring to FIG. 10, playlist database 862 includes broadcast time field 1010, name of music clip field 1020, name of artist field 1030, and name of album field 1040 for storing broadcast information corresponding to music broadcasts from registered radio station having call number KROK. As can be seen, broadcast time field 1010 is configured to store the beginning of the broadcast time for the corresponding music clip as well as the date of broadcast, and each of name of music clip field 1020, name of artist field 1030, and name of album field 1040 is configured to store the corresponding name of the music, the name of the artist and the name of the album for the broadcast music clip.

Indeed, in one embodiment, for each registered radio station, playlist provider 106 may be configured to transmit information related to the broadcasted music to server terminal 105 within a predetermined time from the actual broadcast time. Server terminal 105 is then configured to store the received playlist information for each registered radio stations in storage unit 860. Server terminal 105 may also be configured to update playlist database 862 periodically or at each predetermined interval based on playlist information received from playlist provider 106 such that the data stored in playlist database 862 is maintained as up to date as possible. Furthermore, while only one playlist database 862 is shown in FIG. 8, in accordance with the present invention, server terminal 105 may be configured to generate, store and update a playlist database similar to that shown in FIG. 10 for each radio broadcast station. Moreover, within the scope of the present invention, additional data fields may be incorporated in playlist database 862. Such additional data may include, for example, the number of music clip broadcast over a predetermined time period such as the number of same song broadcast within one day, the frequency information corresponding to the radio station broadcasting the music clips, and the Billboard chart ranking for each broadcast music album.

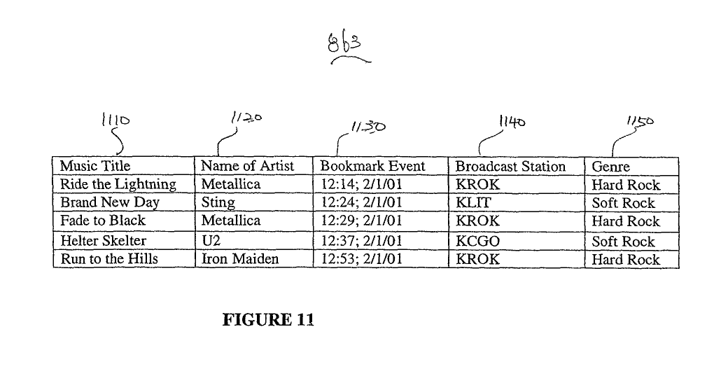

FIG. 11 illustrates one embodiment of a user playlist database of the server terminal data storage unit shown in FIG. 8. Referring to FIG. 11, playlist database 863 stored in server terminal 105 for user John First having user account name “FirstJ” includes music title field 1110, name of artist field 1120 corresponding to the name of the music title stored in music title field 1110, bookmark event field 1130, corresponding broadcast station field 1140, and genre field 1150.

As can be seen from the Figure, for each bookmark entered by John First using his electronic music marker device, once connected and synchronized with server terminal 105 via user terminal 103, information corresponding to the bookmarks are stored in the respective fields of user playlist database 863. For example, it can be seen from FIG. 11 that John First bookmarked the broadcast of the song titled “Ride the Lightning” by Metallica at 12:14 PM on Feb. 1, 2001, and that the song was broadcast from a radio station having call number KROK, the song classified in the hard rock category. In this manner, for each user of music marker device, server terminal 105 is configured to generate and store in user playlist database 862 information corresponding to the music broadcasts received from playlist provider 106 and the bookmarking information from each user's music marker device 101 via user terminal 103. Additionally, server terminal 105 may be configured to add additional data fields to user playlist database 863 as well as to modify and update user playlist database 863.

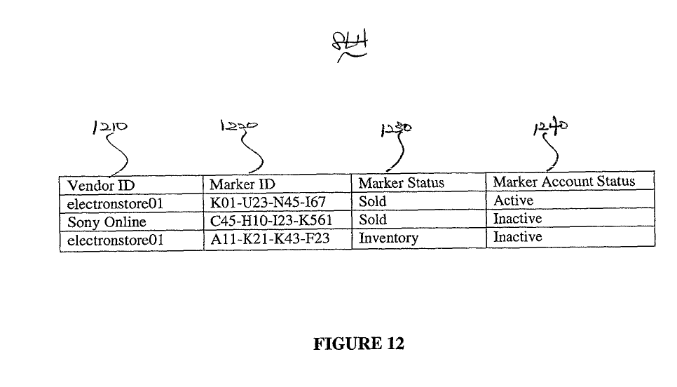

FIG. 12 illustrates one embodiment of a vendor ID database of the server terminal data storage unit shown in FIG. 8. Referring to FIG. 12, vendor ID database 846 includes vendor ID field 1210, marker ID field 1220, marker status field 1230, and marker account status field 1240. In particular, as shown in the Figure, vendor ID field may be configured to store the unique vendor IDs received from one or a plurality of device vendors 107. Furthermore, marker ID field 1220 of vendor ID database 846 may be configured to store music marker ID corresponding to the device vendor from which the marker device was sold to a customer.

Marker status field 1230 may be configured to store the sales status of the music marker, identifying with a “sold” flag for music marker devices that have been sold to customers, and with a “inventory” flag for the music marker devices that remain in the inventory of the corresponding device vendor. Optionally, vendor ID database 864 may further include marker account status field 1240 which, in one embodiment may include the user's e-marker.com account status for the corresponding music marker device purchased from one of the device vendors 107.

For example, it can be seen from FIG. 12 that device vendor having vendor ID “electronstore01” has sold a music marker device having marker device ID “K01-U23-N45-167”, and the e-marker.com account for the user of this music marker device is in active status. In one embodiment, the vendor ID and the corresponding device IDs may be transmitted from device vendor 107 to server terminal 105 after each sales transaction of the corresponding music marker device. Alternatively, the device vendor 107 may be configured to transmit its unique vendor ID to server terminal 105 prior to any sales transaction, and thereafter, to transmit the marker device IDs with the completion of the sales of each corresponding music marker device. Additionally, device vendor 107 may transmit its vendor ID along with all marker device IDs corresponding to each music marker device in its inventory in a single transmission to server terminal 105. In this case, marker status 1230 may be updated upon receiving data transmission indicating the sale of the corresponding marker device from device vendor 107. Furthermore, marker account status field 1240 may be updated, for example, upon marker device user registration at e-marker.com web site, or upon detection of gateway terminal 103 connection for a particular marker device.

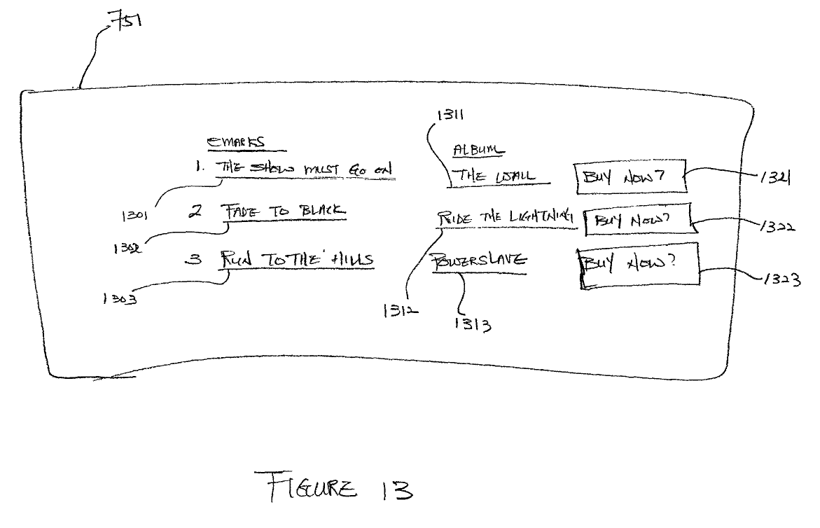

FIG. 13 is a graphical illustration of a user terminal display unit for displaying user electronic music marker device account in the vendor ID tracking system of one embodiment. Referring to FIG. 13, user terminal display unit 751 includes a plurality of bookmarked music clips 1301, 1302, 1303, and a plurality of album information 1311, 1312, 1313 corresponding respectively to each bookmarked music clip 1311,1312, 1313. In one aspect, each bookmarked music clip 1301, 1302, 1303 may be displayed on user terminal display unit 751 as a hypertext link such that a selection using input device 740 (FIG. 7) of user terminal 103 (FIG. 1) may configure user terminal 103 to output a short music clip corresponding to the bookmarked music clip. Furthermore, each of the plurality of album information 131, 1312, 1313 may likewise be configured with a corresponding hypertext link such that a selection of one or more of the plurality of hypertext links corresponding to the album information 1311, 1312, 1311 may display an image or a video clip of the corresponding music album.

Referring to FIG. 13, as shown in the Figure, there is provided purchase selection module 1321,1322, 1323 each corresponding to a respective one of the plurality of album information 1311, 1312, 1313, each corresponding to respective bookmarked music clips 1301, 1302, 1303. In one aspect, the purchase selection module 1321, 1322, 1323 may be displayed on user terminal display unit 751 as an input icon or a hypertext link. As discussed in further detail below, server terminal 105 (FIG. 1) may be configured to display purchase selection module 1321, 1322, 1323 such that when the user selects one of the purchase selection modules 1321, 1322, 1323, the display unit 751 may be redirected to the web-site of the device vendor from which the user has purchased the music marker device. In other words, in the case where the device vendor 107 (FIG. 1) sells both the music marker device as well as the CD, audio cassette, DVD, and the like which provide the basis for the bookmarking operation of the music marker device, server terminal 105 may be configured such that in addition to displaying the bookmarked music clip information on the user terminal display unit 751, the purchase information for the bookmarked music clip may be customized to the music marker device vendor.

By way of an example, in the case where the user purchases the music marker device from an electronics vendor which also sells music CDs and audio cassettes, when the purchaser (or user) of the music marker device operates the device to bookmark broadcast music clips and establishes connection to server terminal 105 to retrieve information corresponding to the bookmarked music clips, the user terminal display unit may be configured to display a hypertext link or a functionally equivalent means to correspond to each bookmarked music clip. In this manner, in the event that the user of the music marker device wishes to purchase a CD or an audio cassette for the bookmarked music clip, the user may be first directed to the web site of the electronics vendor for the purchase of the CD or the audio cassette.

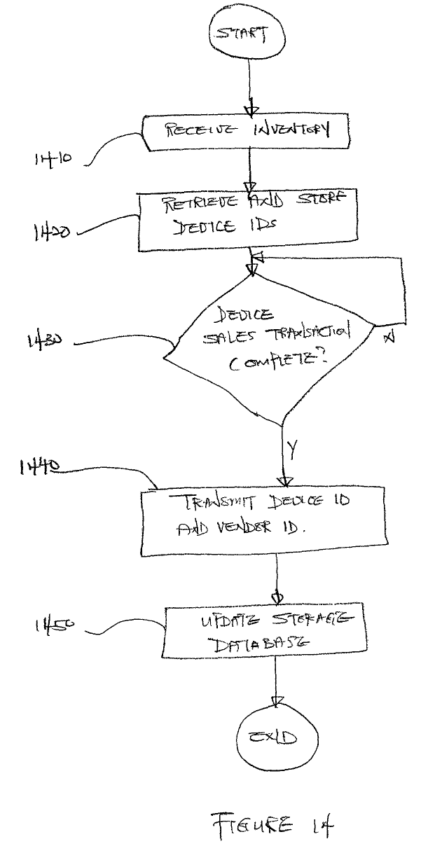

FIG. 14 illustrates a flowchart for illustrating vendor ID tracking system for device vendor of one embodiment. Referring to FIG. 14, at step 1410, device vendor 107 receives music marker devices from the manufacturer, wholesaler or retailer. Thereafter at step 1420, device vendor 107 is configured to retrieve and store the unique device IDs corresponding to the received or purchased music marker devices.

At step 1430, it is determined whether a sales transaction for the music marker devices in inventory has been completed. If the sales transaction has successfully been completed, at step 1440, device vendor 107 may be configured to transmit device ID for the music marker device of the completed sales transaction as well as the vendor ID to server terminal 105. Alternatively, device vendor 107 may be configured to transmit vendor ID and device IDs upon receiving or purchasing the music marker devices. Moreover, device vendor 107 may further be configured such that device IDs from its inventory are transmitted to server terminal 105 periodically with the vendor ID. Thereafter at step 1450, device vendor 107 may be configured to update its storage database to reflect that the device IDs as well as vendor ID has been transmitted to server terminal 105.

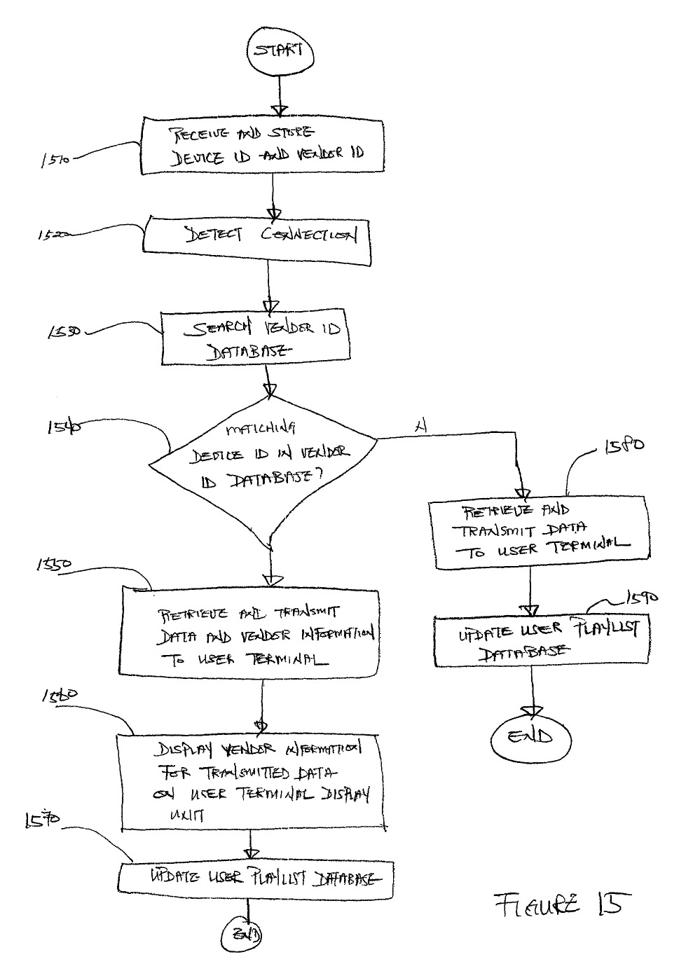

FIG. 15 illustrates a flowchart for illustrating vendor ID tracking system at server terminal of one embodiment. Referring to FIG. 15, at step 1510, server terminal 105 is configured to receive and store device IDs and the corresponding vendor ID. Thereafter, upon detection of user terminal connection at step 1520 and receiving bookmarked music clip information as well as the corresponding device ID, server terminal 105 may be configured to search its vendor ID database 864 to determine whether the received device ID corresponds to a stored vendor ID.

At step 1540, if there is a matching vendor ID for the received device ID, at step 1550, server terminal 105 is configured to retrieve music clip information from playlist database 862 and transmit that information to user terminal 103. Thereafter at step 1560, server terminal 107 is configured to display vendor information corresponding to the transmitted data for the bookmarked music clip on user terminal display unit 751 as, for example, an input icon or a hypertext link correlated with the device vendor. Then, at step 1570, server terminal 107 is configured to update user playlist database 863 to reflect the user's bookmarked music clips.

Referring back to FIG. 15, if at step 1540 server terminal 105 does not find a matching vendor ID in vendor ID database 864 corresponding to the device ID, then at step 1580, server terminal 105 is configured to retrieve from playlist database 862 information corresponding to the bookmarked music clips and to transmit the retrieved information to user terminal 103. Thereafter at step 1590, server terminal 105 is configured to update user playlist database 863 to update stored information corresponding to the bookmarked music clips for the particular device user.

In this manner, in accordance with the various embodiments of the present invention, device vendors may be preferably selected and displayed for purchase of bookmarked music clips who correspond to the actual vendors of the music marker devices. By tracking vendor information or ID corresponding to the music marker devices sold by the vendors, when the user of the music marker device decides to purchase the CD or the audio cassette for the bookmarked music clip, the user may be directed to the web site or contact information for the vendor from whom the user purchased the music marker device. Accordingly, preference may be given to device vendors who, in addition to selling CDs and audio cassettes of broadcast music, offer for sale the music marker devices which, the users may operate to bookmark broadcast music clips.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A vendor tracking system for use with a data marking device, comprising:
a data network;
a user terminal coupled to the data network configured to transmit a signal including information corresponding to marked data;
a vendor terminal configured to transmit a vendor identification code;
a server terminal coupled to the data network configured to receive the signal from the user terminal and the vendor identification code, the server terminal further configured to transmit information corresponding to the vendor identification code and the received signal to the user terminal.

2. The system of claim 1 wherein the signal corresponding to the marked data includes one or more of a time information a date information, and a user identification information.

3. The system of claim 1 further including a data marking device configured to transmit information corresponding to the marked data and data marking device identification code.

4. The system of claim 3 wherein the data marking device identification code is a predetermined length numeric sequence, a predetermined length letter sequence, and a predetermined length combination of numeric and letter sequence.

5. The system of claim 3 wherein the marked data corresponds to one of a radio broadcast music clip, a television broadcast music clip, and a web-cast broadcast music clip.

6. The system of claim 3 wherein the data marking device includes an electronic music marker.

7. The system of claim 1 wherein the user terminal includes one of a personal computer, an internet access enabled personal digital assistant, a Wireless Application Protocol enabled mobile telephone, and an i-mode enabled mobile telephone.

8. The system of claim 1 wherein the data network includes one of a Local Area Network (LAN), a Wide Area Network (WAN), and an internet connection.

9. The system of claim 1 wherein the user terminal and the server terminal are coupled to the data network using one of a TCP/IP protocol and a wireless application protocol.

10. The system of claim 1 wherein the vendor terminal is coupled to the data network.

11. The system of claim wherein the user terminal includes an output unit, the output unit configured to display information received from the server terminal.

12. The system of claim 11 wherein the displayed information includes a vendor sales information corresponding to the purchase of a product for the marked data from a store related to the vendor terminal.

13. The system of claim 12 wherein the store includes one of a retail store of said vendor terminal and an online store of said vendor terminal.

14. The system of claim 12 wherein said vendor sales information displayed on said display unit of said user terminal includes a telephone number of the store, a hypertext link for the store, a facsimile number of the store, an email address of the store, a price information for the purchase of the product, and a delivery information for the delivery of the product.

15. The system of claim 12 wherein marked data includes information corresponding to a broadcast music clip, and further, wherein the product includes one or more of a CD, a video tape, an audio cassette corresponding to the broadcast music clip.

16. The system of claim 1 wherein the server terminal includes a storage unit for storing the vendor identification code received from the vendor terminal and the received signal from the user terminal.

17. The system of claim 1 wherein the vendor terminal is further configured to transmit one or more of a purchased product identification code, the one or more of the purchased product identification code corresponding to the transmitted signal from the user terminal.

18. The system of claim 17 wherein each of the one or more of the purchased product identification code is unique.

19. The system of claim 1 further including a playlist provider configured to transmit to the server terminal information related to the data broadcast from a radio or a television station corresponding to marked data.

20. The system of claim 19 wherein the playlist provider is coupled to the data network.

21. A vendor tracking system for use with a music marker device, comprising:
a data network;
a music marker device configured to store information corresponding to one or more of a music broadcast;
a user terminal coupled to the marker device, the user terminal configured to receive the stored information corresponding to the one or more of a music broadcast from the marker device and an identification code corresponding to the marker device for transmission over the data network;
a vendor terminal configured to transmit a vendor identification code and one or more of purchased marker device identification codes corresponding to the vendor identification code;
a server terminal coupled to the data network configured to receive the information corresponding to the one or more of the music broadcast and the marker device identification code from the user terminal, and the vendor identification code and the one or more the purchased marker device identification codes corresponding to the vendor identification code, the server terminal further configured to compare the identification code received from the user terminal with the one or more of the identification codes received from the vendor terminal, and accordingly, to transmit information to the user terminal based on the comparison.

22. The system of claim 21 wherein the stored information corresponding to the one or more broadcast music includes one or more of a time information corresponding to the music broadcast a date information corresponding to the music broadcast and a geographic information corresponding to the music broadcast.

23. The system of claim 21 wherein each of the one or more of the purchased marker device identification codes is a unique predetermined length numeric sequence, a unique predetermined length letter sequence, and a unique predetermined length combination of numeric and letter sequence.

24. The system of claim 21 wherein the information transmitted from the server terminal to the user terminal includes one or more of a name of the broadcast music, a name of the artist of the broadcast music, a name of the music album.

25. The system of claim 24 wherein the information transmitted from the server terminal to the user terminal further includes purchase information for the purchase of the broadcast music.

26. The system of claim 25 wherein the purchase information includes information corresponding to a store of the vendor terminal.

27. The system of claim 26 wherein the information corresponding to the store includes a hypertext link to an online retail store of the vendor terminal.

28. The system of claim 24 wherein the purchase information includes one or more of cost information for the purchase the broadcast music album, shipping information for the delivery of the broadcast music album purchase, and a payment type information for the purchase of the broadcast music album purchase.

29. The system of claim 24 wherein the information transmitted from the server terminal to the user terminal is displayed on a display unit of the user terminal as one or more of a two-dimensional image, a three-dimensional still image, a dynamic video image, and a text data.

30. The system of claim 21 wherein the user terminal includes one of a personal computer, an internet access enabled personal digital assistant, a Wireless Application Protocol enabled mobile telephone, and an i-mode enabled mobile telephone.

31. The system of claim 21 wherein the data network includes one of a Local Area Network (LAN), a Wide Area Network (WAN), an internet connection, and a wireless data exchange network.

32. The system of claim 21 wherein the user terminal and the server terminal are coupled to the data network using one of a TCP/IP protocol, and a wireless application protocol.

33. A method, comprising:
receiving a vendor identification code and one or more data marking device identification code corresponding to the vendor identification code;
receiving one or more marked data and a corresponding data marking device identification code;
comparing the data marking device identification code corresponding to the vendor identification code with the data marking device identification code corresponding to the one or more marked data; and
transmitting purchase information related to the marked data from a vendor corresponding to the received vendor identification code based on the comparing step.

34. The method of claim 33 further including displaying the transmitted purchase information.

35. The method of claim 33 further including storing the received vendor identification code and the data marking device identification code corresponding to the vendor identification code.

36. The method of claim 35 further including storing the received one or more marked data and the corresponding data marking device identification code.

37. The method of claim 36 further including the step of updating the stored one or more data marking device identification code corresponding to the received vendor identification code and the stored data marking device identification code corresponding to the received marked data.

38. The method of claim 33 wherein each of the one or more data marking device identification code is unique.

39. The method of claim 33 wherein the data marking device identification code corresponding to the vendor identification code and the data marking device identification code corresponding to the marked data are the same.

40. A method, comprising:
purchasing a data marking device from a vendor;
marking one or more broadcast data;
communicating with a data marking device service provider;
receiving purchase information corresponding to the marked one or more broadcast data for purchase from the vendor.

41. The method of claim 40 wherein the data marking device includes an electronic music marker device.

42. The method of claim 40 wherein the one or more broadcast data includes one or more radio broadcast music clip, a television broadcast music clip and a web-cast broadcast music clip.

43. The method of claim 40 wherein the communicating step includes:
connecting to a gateway device; and
accessing a user account in a web domain of said service provider.

44. The method of claim 43 wherein said gateway device includes one or more of a personal computer, an internet access enabled personal digital assistant, a Wireless Application Protocol enabled mobile telephone, and an i-mode enabled mobile telephone.

45. The method of claim 40 wherein the received purchase information includes a purchase price of a music album corresponding to the marked broadcast data from the vendor.

46. The method of claim 40 wherein the communicating step includes establishing a connection with a data network under one of a TCP/IP protocol, and a wireless application protocol.

47. A vendor tracking system for use with a data marking device, comprising:
means for receiving a vendor identification code and one or more data marking device identification code corresponding to the vendor identification code;
means for receiving one or more marked data and a corresponding data marking device identification code;
means for comparing the data marking device identification code corresponding to the vendor identification code with the data marking device identification code corresponding to the one or more marked data; and
means for transmitting purchase information related to the marked data from a vendor corresponding to the received vendor identification code based on the comparing means.
